(19) United States
(12) Patent Application Publication
(10) Pub. No.: US 2025/0137972 A1
(43) Pub. Date: May 1, 2025

(54) ULTRASOUND MEASURING DEVICE AND METHOD FOR MEASURING EXTRUDED PRODUCTS, AS WELL AS EXTRUSION LINE

(71) Applicant: CiTEX Holding GmbH, Melle (DE)

(72) Inventor: Christoph NERLING, Rinteln (DE)

(21) Appl. No.: 18/933,517

(22) Filed: Oct. 31, 2024

(30) Foreign Application Priority Data
Nov. 1, 2023 (DE) 10 2023 130 214.0

(51) Int. Cl. G01N 29/07; G01N 29/11; G01N 29/275; G01N 29/32

(52) U.S. Cl. CPC G01N 29/07; G01N 29/11; G01N 29/275; G01N 29/32; G01N 2291/011; G01N 2291/015; G01N 2291/0235; G01N 2291/02854; G01N 2291/106; G01N 2291/2626

(57) ABSTRACT

The present disclosure relates to an ultrasound measuring device for measuring extruded products in an extrusion line, the ultrasound measuring device comprising multiple sensors, each emitting ultrasound waves and detecting reflected ultrasound waves, the sensors being distributed around an axis and aligned towards the axis, a controller device for activating the sensors and receiving measuring signals from the sensors.

### PRIORITY CLAIM

This application claims priority to DE 10 2023 130 214.0, filed Nov. 1, 2023, which is expressly incorporated by reference herein.

### BACKGROUND

The present disclosure relates to an ultrasound measuring device and a method for measuring extruded products, as well as an extrusion line including the ultrasound measuring device.

### SUMMARY

According to the present disclosure, an ultrasound measuring device and a method for measuring extruded products allowing for a secure and quick measuring are provided herein.

This is provided by an ultrasound measuring device and an ultrasound measuring method according to the independent claims. Preferred further developments are described in the sub-claims. In addition, an extrusion line with an according to the present disclosure ultrasound measuring device according to the present disclosure is provided. The measuring device according to the present disclosure is provided, in particular, for carrying out the method according to the present disclosure.

For example, pipes, hoses, profiles, sheets and also cables and wires may be measured as extruded products. The extruded material may be continuous or e.g., foamed, with, in particular, plastics or rubber being used, including with additives.

The ultrasound sensors shall hereinafter be referred to as sensors.

Thus, multiple sensors are positioned in a preferably helical arrangement around the axis of extrusion or, respectively, around the extruded product. The multiple sensors are offset in relation to one another, in particular, for one thing, by a longitudinal distance in the axial direction of the axis, and, for another, by an offset angle in the circumferential direction, so that the result is, in particular, an essentially or generally helical arrangement. Advantageously, the result is a precisely helical arrangement, i.e., a distance of the multiple sensors with a consistent longitudinal spacing and offset angle of the successive sensors.

This allows for an active-passive measurement as it is shown, in principle, also in FIG. 3, where, however, the multiple sensors are not arranged in a common plane but, rather, successively offset in the direction of extrusion. This allows the removal of the afore-mentioned limit of the measurement sequence frequency. The sensors can be controlled in such a sequence that there will always be a time interval t2″ between two sensors in close proximity Zeit so as to wait for relevant return signals.

Thus, the measurement sequence frequency is no longer limited by the adjacent sensors so that the measurement sequence frequency will be limited solely by the own return signals of each sensor, i.e., to the value f=1/t2″.

Thus, a surprisingly large increase of the measurement sequence frequency is made possible by a relatively simple measure. By arranging the sensors in a helix, advantage of the arrangement in a plane, i.e., in particular, the fully circumferential measurement, and the arrangement in the direction of extrusion, i.e., in particular, the avoidance of undesired reflections, can be combined. Thus, it is possible to perform measurements at a high measurement sequence frequency while still attaining a complete, i.e., 100% coverage. Hereby, the distance in the extrusion direction and the offset angle can be selected such that an active-passive measurement happens in-between sensors, in particular, adjacent sensors and the coverage on the pipe surface is with a relatively small number of sensors.

Instead of a helical arrangement, in principle, it is also possible to employ an arrangement with a different sequence in which the sensors that are successive in the extrusion direction assume the multiple angular positions not exactly successively in the circumferential direction but, e.g., in a step-wise offset. However, according to the present disclosure, a helical arrangement is particularly advantageous because the coverage is high and there will be for each sensor an equal position or, respectively, adjacency of the sensors so that with a high coverage, additionally, the measuring signals can be compared with one another.

Advantageously, one sensor each will be active of the spiral or, respectively, helical arrangement such that it transmits and receives ultrasound waves, and the other sensors will be passive, whereby this function changes appropriately. Hereby, advantageously, one or more additional passive sensors are provided, in particular, at the end of the helix or, respectively, spiral, each receiving an ultrasound signal without actively transmitting a signal. Thus, this at least one additional passive sensor guarantees that in such a measurement always the same number of sensors will receive the signals. Thus, it is possible to generate directly comparable measuring signals.

Thus, in the case of a single helix, which consequently has two open ends, preferably, at least one passive sensor is provided, so as to fully cover 360 degrees; in the case of multiple helixes entwined with one another, e.g., a number of H helixes, accordingly, at least H passive sensors are provided.

The arrangement according to the present disclosure also bears the advantage that no sensors lie directly opposite of one another. Thus, the reflection of the ultrasound signal on the opposite sensor is avoided, which is disturbing, in particular, in the case of very small pipes or hoses. Thus, the ultrasound signals are small in the case of smaller pipes due to the smaller diameter and the ultrasound signals reflected by the opposite sensors are relatively strong.

According to an advantageous embodiment, additional reflectors may be fitted to mask the returning signals. Even attenuating elements, in which the ultrasound signals bleed out, may be fitted opposite the sensor, which would not be possible, e.g., in a circular arrangement. This allows the measurement sequence frequency to be increased further, in particular, to a value of up to IFF=1/t1″, resulting from the measuring frequency of each sensor without return signals.

Thus, the measuring device according to the present disclosure is also different from, e.g., a system with two measuring planes in each of which a measurement is carried out, e.g., each in the form of an active-passive measurement, because, according to the present disclosure, it is not separate measurements in multiple planes but, rather, one active-passive measurement between the sensors offset in the extrusion direction that is performed, and the circumferential coverage is achieved only by the multiple sensors offset in the extrusion direction.

According to the present disclosure multiple spirals or, respectively, helix arrangements of sensors may be interlaced with one another, i.e., the multiple spirals are offset in relation to each other in the axial direction. The number of sensors in one helix or, respectively, spiral is not limited in principle, i.e., any number of sensors may be provided in one helix.

Preferably, merely one or more helix arrangements or, respectively, spirals are provided. In particular, in each helix the row of sensors is controlled via serial commands. In particular, further sensors outside the helix, in particular, sensors whose sound waves overlap with the sensors of the helix are not activated.

In the serial controlling of a helix the sequence of the sensors may correspond to the geometric sequence in the helix or also deviate from the geometric sequence in the helix, so that a controlling scheme leaping in relation to the geometric arrangement is attained. In the case of a helix of e.g., 20 sensors, i.e., the geometric arrangement from sensor 1 to sensor 20 in the helix, the controlling may be carried out, e.g., in the sequence sensor 1, sensor 10, sensor 2, sensor 11. This can help reduce the sensors mutually influencing each other among other things; moreover, this facilitates the electronic controlling.

Thus, according to the present disclosure, even extruded products such as pipes running at very high speeds can be measured securely with a high coverage, in particular, of 100%.

Furthermore, spaced-apart sensors may transmit not only in the sequence one directly following the other but also with temporal overlap or even simultaneously, in particular, when the reflections do not or not to a relevant extent overlap and therefore the passive sensors only pick up signals from one of the transmitting sensors. Thus, this embodiment may be configured, in principle, also as an operation of multiple partial helixes connected in series together forming the helix, where in each of the partial helixes one sensor each will be active. Thus, e.g., the helix may be pulled apart widely enough to avoid the reception of reflections von two transmitting sensors in an operation with temporal overlap. Thus, e.g., in a helix with 36 sensors, e.g., sensor 1 and sensor 18 may be operated simultaneously or with little offset (to improve the electronic controlling), in order to gain even more speed. In principle, potentially, even four sensors may be operated simultaneously if the distances, i.e., in particular, the longitudinal spacings are sufficient and e.g., always sensors with an angular offset of 90 degrees are activated.

Hereby, the terms “avoiding the reception of undesired reflections” or “when the reflections do not or not to a relevant extent overlap” in particular, are to be understood that a sensor receiving reflections from one of the active sensors does not also receive first, second or third reflections of the signals of another active sensor, since the higher reflections-as explained above-are generally too weak.

However, a further embodiment, however, may provide for purposeful commands from e.g., two helixes, where the e.g., two sensors lie opposite one another, so as to allow for a direct through measurement, in particular, for the direct determination of a dimension such as e.g., an interior diameter and/or exterior diameter.

According to the present disclosure, it is possible, in particular, to determine one or more of the following properties from the measuring signals;
one or more layer thickness(es),
an exterior diameter and/or interior diameter,
faults, e.g., shrinkage cavities, i.e., air inclusions, and/or inclusions such as e.g., from melting loss, and/or
irregularities of the surfaces, e.g., including sagging, occurring as a slight deformation of the inner wall of a pipe caused by material flowing downwards and permissible within certain tolerances, provided that the layer thickness does not become too thin in certain places,
material properties of the extruded product, in particular, a speed of sound in the material and/or an acoustic impedance, where these material properties allow inferences to be drawn, e.g., as to the composition of the material and/or the temperature and/or a solidification.

Furthermore, depending on the measurement and determination, a regulation of the extrusion line can be carried out, e.g., by controlling the extruder and/or the haul-off, to be able to directly modify geometric properties and material properties of the extruded product. Thus, the quick and secure measuring according to the present disclosure also allows for an advantageous regulation.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 shows an extrusion line with an ultrasound measuring device according to an embodiment of the present disclosure;

FIG. 2 shows on the left side an axial view and on the right side a side view of an extruded pipe with an ultrasound measuring device according to an embodiment of the present disclosure;

FIG. 3 shows an axial view of a measuring device in active-passive measurement;

FIG. 4 is a representation of an active measuring with two return signals; and

FIG. 5 shows the measuring signal of the measurement from FIG. 4.

### DETAILED DESCRIPTION

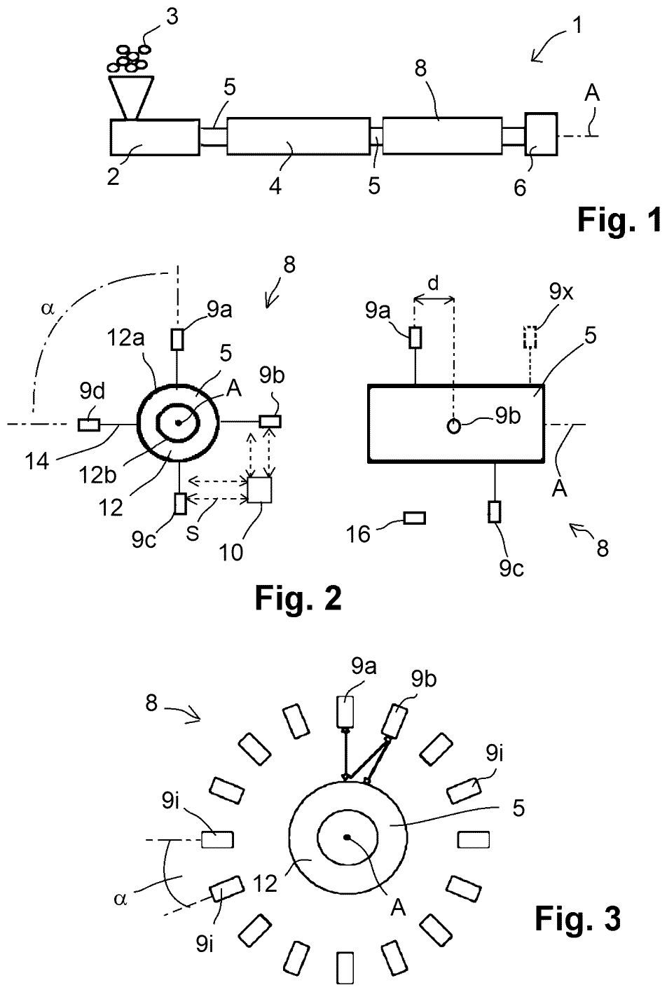

The extrusion line 1 of FIG. 1 includes an extruder 2, a cooling tank 4 and a haul-off 6 with a saw. Bulk material 3 is fed to the extruder 2 in its hopper which will be continuously melted by the extruder 2 and extruded along an axis A as a pipe 5. The pipe 5 is pulled through the haul-off 6 provided at the end of the extrusion line 1 and hereby guided through the cooling tank 4, in which the pipe 5 initially formed by a hot, molten material is cooled. Along the extrusion line 1 one or more ultrasound measuring devices 8 are provided, e.g., s shown, between the cooling tank 4 and the haul-off 6, or even before the cooling tank 4. According to FIGS. 2, 3, the ultrasound measuring device 8 in each case is provided with multiple sensors 9i, i.e., 9a, 9b, 9c, 9d . . . auf, i.e., with a general indexing of a sensor as sensor 9i, where i=a, b, c, d, . . . . One or more passive sensors to be described below which complement the measurement are designated as 9x.

A controller device 10, indicated on the left side in FIG. 2, controls the ultrasound measuring device 8 in that it determines the measuring sequence of the individual sensors 9i and picks up and jointly evaluates the measuring signals S(t) of the individual sensors 9i. The controller device 10 may also be, e.g., designed as a multi-component system, e.g., also with components being provided within the individual sensors 9i.

In the ultrasound measuring device 8 according to the present disclosure the multiple sensors 9a, 9b, 9c, 9d, . . . , 9i are offset not only in the circumferential direction around the pipe wall 12 or, respectively, the axis A, but, additionally, in the direction of extrusion, i.e., along the axis A. This results in an arrangement of the individual sensors 9i in a helical or, respectively, spiral configuration, with overlapping offset in the circumferential direction and longitudinal direction. Advantageously, an even helix is formed and activated in the sequence of the helix, i.e., from one end to the other.

FIG. 2 shows an embodiment of an ultrasound measuring device 8 according to the present disclosure including four sensors 9a, 9b, 9c, 9d, which are offset accordingly each in relation to one another in the circumferential direction about an offset angle alpha=90° and in the direction of extrusion or, respectively, along the axis A each by a longitudinal spacing d. Because the multiple sensors 9a, 9b, 9c, 9d do not lie in a single plane but are offset in the direction of extrusion or, respectively, the direction of the axis A, no sensors lie in direct opposition with one another. In principle, a large number of sensors 9i so can be arranged, in this case only four sensors are shown for simplicity. Often, e.g., twelve to thirty six sensors 9i are employed, i.e., i=1, . . . ,36.

Preferably, here, as shown on the right side of FIG. 2, a further sensor 9x is provided in the next following position of the helix, i.e., again in the same circumferential position as the first sensor 9a and in the direction of the axis A behind the sensor 9d, which, however, always passively receives in the measurements but does not subsequently actively transmit, i.e., it will be skipped in the sequence of the active activation of the sensors 9i, so that after the sensor 9d it will be the sensor 9a again that transmits. This allows the sensors 9i each detecting essentially equal or, respectively, similar wave pattern allowing their signals S to be compare with one another.

FIG. 3 shows—corresponding to the left side in FIG. 2—an ultrasound measuring device 8 including multiple sensors 9i and active-passive measurement in an axial view, where in this view, i.e., without showing the longitudinal spacing in the axial direction, in FIG. 3 there is the same representation as in comparative devices with a planar arrangement of the sensors; see the description above in relation to FIG. 3. In the embodiment with a longitudinal spacing d according to the present disclosure, again, the last sensor 9x in the helical arrangement can only receive passively, i.e., it will be skipped in the cyclic activation of the active function.

Owing to the helical arrangement the area lying opposite the sensors 9i will not be occupied initially. Thus, according to FIG. 2, sound affecting means 16 may be provided opposite the individual sensors 9i, in particular,
reflectors masking the reflections 14-1 through 14-5 of FIG. 2 and/or
sound absorbing means Mittel attenuating or preventing the reflections 14-1 through 14-5 of FIG. 2, so that the creation of return signals and additional measuring peaks can be further reduced.

The present disclosure relates, in particular, to the following clauses:

Clause 1 Ultrasound measuring device (8) for measuring extruded products (5) in an extrusion line (1), the ultrasound measuring device (8) comprising
multiple sensors (9a, 9b. 9c, 9d, . . . 9i), each emitting ultrasound waves (14) and detecting reflected ultrasound waves (14-1), the sensors (9a, 9b, 9c, 9d, . . . 9i,) being distributed around an axis (A) and aligned towards the axis (A),
a controller device (10) for activating the sensors (9a, 9b, 9c, 9d, . . . 9i) and receiving measuring signals (S) from the sensors (9i),
characterized in that
the multiple sensors (9i) are arranged, in relation to one another,
helical or spiral around the axis (A), and/or
sequentially offset in relation to one another both in the circumferential direction around the axis (A) and in the direction of the axis (A),
the controller device (10) activating the sensors (9i) in such a way that always one sensor (9a) transmits and detects and the other sensors (9b, 9c, 9d, . . . , 9i) detect passively.

Clause 2 Ultrasound measuring device (8) according to clause 1, the controller device (10) activating the sensors (9a, 9b, 9c, 9d, . . . 9i) in such a way that successively always another one of the sensors actively transmits and detects and the other sensors detect passively.

Clause 3 Ultrasound measuring device (8) according to one of the above clauses, the sensors (9a, 9b, 9c, 9d, . . . 9i) forming a symmetric helix, with an even offset angle (alpha) in the circumferential direction and an even longitudinal spacing (d) in the direction of the axis (A).

Clause 4 Ultrasound measuring device (8) according to one of the above clauses, the controller device (10) activating the helical arrangement of the multiple sensors (9a, 9b, 9c, 9d, . . . 9i) sequentially in series in such a way that always one of the sensors (9a) is active and transmits and receives, and the other sensors (9b, 9c, 9d, . . . , 9i) are passive and detect, in particular, in a cyclic active activation of all sensors but at least one further, in particular, last sensor (9x), the at least one further sensor (9x) detecting only passively, so as generate equal or corresponding measuring signals (S) of the multiple measurements.

Clause 5 Ultrasound measuring device (8) according to one of the above clauses, the controller device (10) being adapted to activate the helical arrangement of sensors (9a, 9b, 9c, 9d, . . . 9i) in series in a sequence deviating from the geometric sequence in the helix.

Clause 6 Ultrasound measuring device (8) according to one of the above clauses, the controller device being adapted to activate at least two sensors spaced apart in the geometric sequence in a manner temporally overlapping and/or simultaneously as active sensors (9a), in particular, when reflections are not overlapping, where the passive sensors pick up only signals from one of the transmitting sensors.

Clause 7 Ultrasound measuring device (8) according to one of the above clauses, where multiple helical arrangements of sensors (9a, 9b, 9c, 9d, . . . 9i) may be interlaced with one another in such a way that the spirals or helixes are offset against one another in the axial direction, in particular, such that no sensors of the multiple helical arrangements lie opposite one another, in particular, with separate activation of the individual helixes.

Clause 8 Ultrasound measuring device (8) according to one of the above clauses, where at least two helical arrangements of sensors (9a, 9b, 9c, 9d, . . . 9i) are interlaced with one another in such a way that at least some of the sensors of the at least two helixes lie opposite one another, the controller device (10) carrying out a determination of an interior diameter and/or exterior diameter of the extruded product from a measurement in which an active sensor (9a) of one of the helixes transmits and the sensor of the other helix lying opposite receives.

Clause 9 Ultrasound measuring device (8) according to one of the above clauses, where opposite at least some sensors (9a, 9b, 9c, 9d, . . . 9i) lies a sound affecting means (16), e.g., a reflector or an attenuating means, so as to prevent or reduce reflections (14-2).

Clause 10 Ultrasound measuring device (8) according to one of the above clauses, the controller device (10) being adapted to determine one or more of the following properties from the measuring signals (S), in particular, from time-of-flight differences and/or the allocation of the passive to the active sensor (9i): one or more layer thickness(es) (d), an exterior diameter and/or interior diameter, faults, e.g., shrinkage cavities and/or inclusions and/or irregularities of the surfaces (12a, 12b), e.g., sagging (5), material properties of the extruded product, in particular, a speed of sound in the material and/or an acoustic impedance.

Clause 11 Extrusion line (1), comprising: an extruder (2) for receiving bulk material (3) and putting out an extruded product, in particular, a pipe (5), along an axis (A), a haul-off (6) removing the extruded product (5), a cooling tank (4) through which the extruded product (5) is guided, and an ultrasound measuring device (8) according to one of the above clauses, arranged around the axis (A), for measuring the extruded product (5).

Clause 12 Extrusion line (1) according to clause 11, the controller device (10) being adapted to activate multiple sensors (9a, 9b, 9c, 9d, . . . 9i) of the ultrasound measuring device (8) at such a frequency that a fully circumferential measuring of the extruded product (5) is provided, in particular, at a measurement sequence frequency (IFF) that is independent of the longitudinal spacing (n) of the sensors (9i) in relation to one another.

Clause 13 Extrusion line (1) according to clause 11 or 12, comprising multiple ultrasound measuring devices (8) according to one of the above clauses 1 through 10, in particular, entwined with one another and/or in a common axial measuring region, with an arrangement of the sensors of the multiple spirals or helical arrangements offset against one another.

Clause 14 Method for measuring an extruded product (5), where the extruded product (5) is transported during the extrusion process along an axis (A) and continuously measured by at least one ultrasound measuring device (8) including multiple sensors (9a, 9b, 9c, 9d . . . 9i), the multiple sensors (9i) being
arranged successively in both the circumferential direction around the axis (A) and offset in relation to one another in the direction of the axis (A), and/or
arranged helically or spirally around the axis (A),
where in an active-passive measurement always one of the sensors (9a) transmits and receives and the other sensors (9b, 9c, 9d, . . . 9i) detect passively.

Clause 15 Method according to clause 14, where one of the multiple sensors (9a, 9b, 9c, 9d, . . . 9i) each is activated successively as the active sensor (9a), and the measurement is carried out repeatedly in a cycle, in particular, each of the sensors or all sensors but at least one last sensor (9x).

Clause 16 Method according to clause 15, where at least one last sensor (9x) of the multiple sensors (9a, 9b, 9c, 9d, . . . 9i) in the sequential arrangement merely measures passively so as to generate equal measuring signals.

Clause 17 Method according to one of the clauses 14 through 16, where the extruded product (5) is measured continuously in its full circumference.

Clause 18 Method according to one of the clauses 14 through 17, where an extruded product (5) is measured from the group consisting of or comprising: pipes, hoses, profiles, sheets, cables, wires, in particular, made of plastics or rubber e.g., made of continuous or foamed material.

Clause 19 Method according to one of the clauses 14 through 18, where one or more of the following properties are determined from the measuring signals (S): one or more layer thickness(es) (d), an exterior diameter and/or interior diameter, faults, e.g., shrinkage cavities and/or inclusions and/or irregularities of the surfaces (12a, 12b), e.g., sagging, material properties of the extruded product, in particular, a speed of sound in the material and/or an acoustic impedance.

In extrusion processes goods like pipes, profiles and sheets made of plastics, including foam, are manufactured, among other things. In order to produce such products in an accurate and cost-efficient manner, layer thickness measurements may be carried out, wherein the extruded products are measured inline, i.e., during manufacturing in the extrusion line. This allows for the production to be interrupted or readjusted immediately upon recognition of faults. In particular, pipes should have a precise determination of the layer thickness. In the case of gas pipes and other high precision pipes 100% measurements are common, wherein the pipes are measured around their entire circumference.

Furthermore, extrusion processes may be used for applying a plastic or rubber sleeve or, respectively, plastic or rubber layer around an inner core, such extrusion coating or extrusion jacketing being used, in particular, in manufacturing cables, electric wires and e.g., even filaments, since the extrusion allows for a cost-efficient continuous process while creating even layers. Thus, such products also require guaranteed constant layer thicknesses without faults

In comparative ultrasound measurements extruded products are guided though a coupling medium, for example water, and layer thicknesses are determined by means of time-of-flight measurements. Hereby, the time between emitting and receiving the signals is determined, the resolution being determined by the spatial arrangement of the sensors and the speed of sound in the coupling medium water.

Comparative sensors may be arranged a ring gauge circularly around the extruded product. Such a measuring arrangement is simple to produce and cost-efficient. In principle, the signals emitted from a sensor can by picked up by the sensor itself or an adjacent one. When a large number of sensors are used to allow for a full, i.e. 100%, measurement of the pipe, then the distance is increased and the used number of sensors places around the pipe.

Thus, the comparative sensors are each both transmitter and receiver; the emit a signal as ultrasound waves and re-receive the reflected signal after a time of flight. When measuring pipes, the front pipe wall may be measured which allows for a reflection of ultrasound waves each on its exterior surface and interior surface so that two returning peaks following each other in rapid succession can be generated and measured.

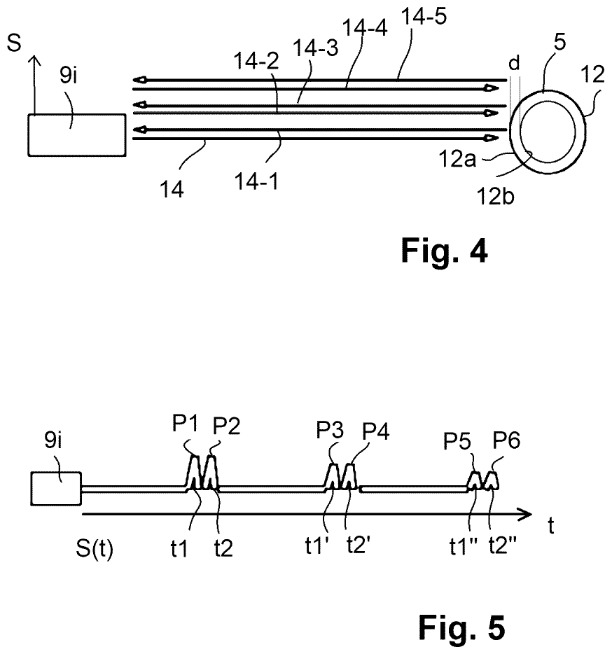

FIGS. 4 and 5 show a comparative measuring principle of a sensor 9a in measuring a pipe 5 with a pipe wall 12 having a layer thickness d. The sensor 9i emits ultrasound waves 14 through the coupling medium onto the pipe wall 12 of the pipe 5, where the ultrasound waves 14 are first partially reflected on the exterior surface 12a of the pipe wall 12 and partially penetrate the pipe wall 12, whereupon a part of the ultrasound waves 14 is partially reflected on the interior surface 12b again. The reflected ultrasound waves 14-1 travel back to the sensor 9i and where they are detected so that it is possible to carry out the time-of-flight measurement shown in FIG. 5. FIG. 5 shows the temporal measurement diagram, i.e., the signal S with the time t on the x-axis. At time t1 a first peak P1 is detected corresponding to the reflection on the exterior surface 12a; subsequently, at time t2 a second peak p2 is detected corresponding to the reflection on the interior surface 12b so that the layer thickness d is determined from the time difference t2-t1 based on the speed of sound.

However, often new reflections of the reflected ultrasound waves 14-1 will appear again at the sensor 9i which travel back again to the pipe wall 12 of the pipe 5 as twice reflected ultrasound waves 14-2 and again from there as so-called return signals, i.e., in this case as thrice reflected ultrasound waves 14-3, to the sensor 9i where they generate the peaks P3 and P4 at the times t1′and t2′. Subsequently the return signals 14-3 may be reflected on the sensor 9i thereby traveling again as reflected ultrasound waves 14-4 to the pipe wall 12 so that new reflection generates return signals 14-5 accordingly leading to peaks P5 and P6 at times t1″and t2″.

Thus, the return signals lead to a measuring signal S(t) with a successive sequence of measuring peaks that may therefore become superimposed with measuring peaks of subsequent measurements. These return signals limit the time and thereby the frequency of the measurement. The return signals gradually decrease in their intensity so that they can be discerned from the new measuring signals. Thus, generally, one should wait for the third return signals so that the sensor can start emitting again.

FIG. 3 shows the measuring principle of an active-passive measurement for measuring the entire circumference of the pipe wall 12. The measuring device 8 comprises multiple sensors 9a, 9b, . . . 9i arranged circularly around pipe 5 and aligned towards the pipe 5 or, respectively, the axis A. The active sensor 9a again emits ultrasound waves 14 towards the pipe wall 12 of the pipe 5 which, as shown in FIG. 4, are partially reflected back to the active sensor 9a and sensed by it. Further, a part of the ultrasound waves 14 is also reflected outside the sensor axis, for one thing, due to the emission cone of the ultrasound waves 14, which accordingly are subsequently reflected angularly on the surfaces 12a, 12b. Furthermore, the surfaces 12a, 12b of the pipe wall 12 will exhibit unevenness and faults possibly including, e.g., faults in the pipe wall 12, e.g., shrinkage cavities or, respectively, air inclusions which will then reflect the ultrasound waves 14 angularly. Thus, these angularly reflected ultrasound waves 14-1 provide relevant information and, provided there is sufficient coverage, can be detected by another sensor 9i. Thus, when the sensor 9a is active the other sensors 9b, . . . , 9i are initially passive and receive reflected ultrasound waves 14-1 as passive sensors. After the sensor 9a was active, subsequently, the further sensors 9b, . . . , 9i will be active each following one another, so that then the respective other sensors are passive and pick up angularly reflected ultrasound waves 14-1. Such an active-passive measurement improves the coverage on the pipe 5 and allows for an all-around detection or, respectively, 100% measurement.

Thus, in the active-passive measurement the multiple sensors 9i transmit successively one after another, where after emission of the ultrasound waves from one of the sensors 9i one should also wait in each case for the return signals described above with reference to FIG. 4. The term measurement sequence frequency refers to the frequency at which a complete measurement of the circumference is carried out. Thus, in the above-described system of FIGS. 3, 4, 5, i.e., when in a circular arrangement each sensor 9i should wait for the second return signal 14-5 at time t2″, the measurement sequence frequency is limited to f=1/(t2″*n), where n is the number of sensors. When measuring very small pipes, ultrasound signals are additionally reflected on the opposite sensors, which may then also interfere with the measuring signals as return signals.

A complete, i.e., 100% measurement, of the surface is common for gas pipes and other high precision pipes but may also be carried out with other extruded products. Thus, in this type of measurement the number of sensors will be potentially increased in order to allow the circumference of the pipe and therewith the surface of the pipe to be measured fully. Therefore, a particularly high measurement sequence frequency is needed. This allows for even small faults in the pipe to be detected and later rejected. The production of the pipes is fully controlled so as to prevent any production of faulty pipes and thereby to provide good production with little scrap at all times. It is therefore important to be able to make measurement quickly in order to provide the complete measuring of the pipe surface. This allows even pipes from high-efficiency extruders running at very high productions speeds to be measured.

Thus, in the above-described measuring devices the limitation of the measurement sequence frequency presents a problem, in particular, for 100% measurements and high productions speeds.

A comparative ultrasound detection arrangement for fault recognition allowing for an internal fault recognition of a material to be tested in its interior space, where the material has a circular cross-section and multiple transducers are arranged circularly around the material to be examined. Hereby, probes are arranged such that they surround the material to be tested. Hereby, an exciter unit generates ultrasound waves which pass through the material to be tested at different positions, whereby multiple transducers vibrate simultaneously or at multiple times thereby creating sound waves in the material.

A comparative method and a comparative device for an imaging ultrasonic inspection of a three-dimensional workpiece, where ultrasound waves are coupled into the workpiece using one or multiple ultrasonic transducers and reflected ultrasound waves inside the workpiece are received by multiple ultrasonic transducers and converted into ultrasound signals which are used as a basis of non-destructive imaging ultrasonic inspection. Herby, ultrasonic transducers are provided in a spatial distribution around the workpiece and ultrasound signals are emitted successively.

A comparative measuring method for determining the wall thickness of an extruded plastic profile, in particular, a pipe, using the impulse echo method using at least one ultrasonic sensor transmitting perpendicularly onto the surface of the plastic profile with a coupling medium in-between for detecting a time-of-flight difference between front and rear wall echoes. Hereby, influences of fluctuations in the body temperature of the plastic profile on the measurement are compensated, where a calibration of the wall thickness measuring is provided.

A comparative method for carrying out an online measurement the degree of bending of a rod material using ultrasound waves. Hereby, a rod to be inspected is guided through two guide sleeves provided in a water tank, where the distance between an ultrasound probe and the surface of the rod material is measured from various directions, where subsequently the degree of bending of the rod material is evaluated on the basis of the deviation between the measurement value of the distance between the ultrasound probe and the surface compared to a theoretical value.

The present disclosure is based on the object of creating an ultrasound measuring device and a method for measuring extruded products allowing for a secure and quick measuring.

This task is solved by an ultrasound measuring device and an ultrasound measuring method according to the independent claims. Preferred further developments are described in the sub-claims. In addition, an extrusion line with an according to the present disclosure ultrasound measuring device according to the present disclosure is provided. The measuring device according to the present disclosure is provided, in particular, for carrying out the method according to the present disclosure.

For example, pipes, hoses, profiles, sheets and also cables and wires can be measured as extruded products. The extruded material may be continuous or e.g., foamed, with, in particular, plastics or rubber being used, including with additives.

The ultrasound sensors shall hereinafter be referred to as sensors.

Thus, multiple sensors are positioned in a preferably helical arrangement around the axis of extrusion or, respectively, around the extruded product. The multiple sensors are offset in relation to one another, in particular, for one thing, by a longitudinal distance in the axial direction of the axis, and, for another, by an offset angle in the circumferential direction, so that the result is, in particular, an essentially helical arrangement. Advantageously, the result is a precisely helical arrangement, i.e., a distance of the multiple sensors with a consistent longitudinal spacing and offset angle of the successive sensors.

This allows for an active-passive measurement as it is shown, in principle, also in FIG. 3, where, however, the multiple sensors are not arranged in a common plane but, rather, successively offset in the direction of extrusion. This allows the removal of the afore-mentioned limit of the measurement sequence frequency. The sensors can be controlled in such a sequence that there will always be a time interval t2″ between two sensors in close proximity Zeit so as to wait for relevant return signals.

Thus, the measurement sequence frequency is no longer limited by the adjacent sensors so that the measurement sequence frequency will be limited solely by the own return signals of each sensor, i.e., to the value f=1/t2″.

Thus, a surprisingly large increase of the measurement sequence frequency is made possible by a relatively simple measure. By arranging the sensors in a helix, advantage of the arrangement in a plane, i.e., in particular, the fully circumferential measurement, and the arrangement in the direction of extrusion, i.e., in particular, the avoidance of undesired reflections, can be combined. Thus, it is possible to perform measurements at a high measurement sequence frequency while still attaining a complete, i.e., 100% coverage. Hereby, the distance in the extrusion direction and the offset angle can be selected such that an active-passive measurement happens in-between sensors, in particular, adjacent sensors and the coverage on the pipe surface is with a relatively small number of sensors.

Instead of a helical arrangement, in principle, it is also possible to employ an arrangement with a different sequence in which the sensors that are successive in the extrusion direction assume the multiple angular positions not exactly successively in the circumferential direction but, e.g., in a step-wise offset. However, according to the present disclosure, a helical arrangement is particularly advantageous because the coverage is high and there will be for each sensor an equal position or, respectively, adjacency of the sensors so that with a high coverage, additionally, the measuring signals can be compared with one another.

Advantageously, one sensor each will be active of the spiral or, respectively, helical arrangement such that it transmits and receives ultrasound waves, and the other sensors will be passive, whereby this function changes appropriately. Hereby, advantageously, one or more additional passive sensors are provided, in particular, at the end of the helix or, respectively, spiral, each receiving an ultrasound signal without actively transmitting a signal. Thus, this at least one additional passive sensor provide that in such a measurement always the same number of sensors will receive the signals. Thus, it is possible to generate directly comparable measuring signals. Thus, in the case of a single helix, which consequently has two open ends, preferably, at least one passive sensor is provided, so as to fully cover 360 degrees; in the case of multiple helixes entwined with one another, e.g., a number of H helixes, accordingly, at least H passive sensors are provided.

The arrangement according to the present disclosure also bears the advantage that no sensors lie directly opposite of one another. Thus, the reflection of the ultrasound signal on the opposite sensor is avoided, which is disturbing, in particular, in the case of very small pipes or hoses. Thus, the ultrasound signals are small in the case of smaller pipes due to the smaller diameter and the ultrasound signals reflected by the opposite sensors are relatively strong.

According to an advantageous embodiment, additional reflectors may be fitted to mask the returning signals. Even attenuating elements, in which the ultrasound signals bleed out, may be fitted opposite the sensor, which would not be possible, e.g., in a circular arrangement. This allows the measurement sequence frequency to be increased further, in particular, to a value of up to IFF=1/t1″, resulting from the measuring frequency of each sensor without return signals.

Thus, the measuring device according to the present disclosure is also different from, e.g., a system with two measuring planes in each of which a measurement is carried out, e.g., each in the form of an active-passive measurement, because, according to the present disclosure, it is not separate measurements in multiple planes but, rather, one active-passive measurement between the sensors offset in the extrusion direction that is performed, and the circumferential coverage is achieved only by the multiple sensors offset in the extrusion direction.

According to the present disclosure multiple spirals or, respectively, helix arrangements of sensors may be interlaced with one another, i.e., the multiple spirals are offset in relation to each other in the axial direction. The number of sensors in one helix or, respectively, spiral is not limited in principle, i.e., any number of sensors may be provided in one helix.

Preferably, merely one or more helix arrangements or, respectively, spirals are provided. In particular, in each helix the row of sensors is controlled via serial commands. In particular, further sensors outside the helix, in particular, sensors whose sound waves overlap with the sensors of the helix are not activated.

In the serial controlling of a helix the sequence of the sensors may correspond to the geometric sequence in the helix or also deviate from the geometric sequence in the helix, so that a controlling scheme leaping in relation to the geometric arrangement is attained. In the case of a helix of e.g., 20 sensors, i.e., the geometric arrangement from sensor 1 to sensor 20 in the helix, the controlling may be carried out, e.g., in the sequence sensor 1, sensor 10, sensor 2, sensor 11. This can help reduce the sensors mutually influencing each other among other things; moreover, this facilitates the electronic controlling.

Thus, according to the present disclosure, even extruded products such as pipes running at very high speeds can be measured securely with a high coverage, in particular, of 100%.

Furthermore, spaced-apart sensors may transmit not only in the sequence one directly following the other but also with temporal overlap or even simultaneously, in particular, when the reflections do not or not to a relevant extent overlap and therefore the passive sensors only pick up signals from one of the transmitting sensors. Thus, this embodiment may be configured, in principle, also as an operation of multiple partial helixes connected in series together forming the helix, where in each of the partial helixes one sensor each will be active. Thus, e.g., the helix may be pulled apart widely enough to avoid the reception of reflections von two transmitting sensors in an operation with temporal overlap. Thus, e.g., in a helix with 36 sensors, e.g., sensor 1 and sensor 18 may be operated simultaneously or with little offset (to improve the electronic controlling), in order to gain even more speed. In principle, potentially, even four sensors may be operated simultaneously if the distances, i.e., in particular, the longitudinal spacings are sufficient and e.g., always sensors with an angular offset of 90 degrees are activated.

Hereby, the terms “avoiding the reception of undesired reflections” or “when the reflections do not or not to a relevant extent overlap” in particular, are to be understood that a sensor receiving reflections from one of the active sensors does not also receive first, second or third reflections of the signals of another active sensor, since the higher reflections—as explained above—are generally too weak.

However, a further embodiment, however, may provide for purposeful commands from e.g., two helixes, where the e.g., two sensors lie opposite one another, so as to allow for a direct through measurement, in particular, for the direct determination of a dimension such as e.g., an interior diameter and/or exterior diameter.

According to the present disclosure, it is possible, in particular, to determine one or more of the following properties from the measuring signals;
one or more layer thickness(es),
an exterior diameter and/or interior diameter,
faults, e.g., shrinkage cavities, i.e., air inclusions, and/or inclusions such as e.g., from melting loss, and/or
irregularities of the surfaces, e.g., including sagging, occurring as a slight deformation of the inner wall of a pipe caused by material flowing downwards and permissible within certain tolerances, provided that the layer thickness does not become too thin in certain places,
material properties of the extruded product, in particular, a speed of sound in the material and/or an acoustic impedance, where these material properties allow inferences to be drawn, e.g., as to the composition of the material and/or the temperature and/or a solidification.

Furthermore, depending on the measurement and determination, a regulation of the extrusion line can be carried out, e.g., by controlling the extruder and/or the haul-off, to be able to directly modify geometric properties and material properties of the extruded product. Thus, the quick and secure measuring according to the present disclosure also allows for an advantageous regulation.

The present disclosure relates to an ultrasound measuring device (8) for measuring extruded products (5) in an extrusion line, the ultrasound measuring device comprising
multiple sensors (9a, 9b. 9c, 9d, . . . 9i), each emitting ultrasound waves (14) and detecting reflected ultrasound waves (14-1), the sensors (9a, 9b, 9c, 9d, . . . 9i,) being distributed around an axis (A) and aligned towards the axis (A),
a controller device (10) for activating the sensors (9a, 9b, 9c, 9d, . . . 9i) and receiving measuring signals (S) from the sensors,
characterized in that the multiple sensors (9i) are arranged, in relation to one another,
sequentially offset in relation to one another both in the circumferential direction around the axis (A) and in the direction of the axis (A), and/or
helical or spiral around the axis (A),
   the controller device (10) activating the sensors (9i) in such a way that always one sensor (9a) transmits and detects and the other sensors (9b, 9c, 9d, 9i) detect passively.

### List of Reference Numerals

1 extrusion line

2 extruder

3 bulk material, in particular, made of plastics

4 cooling tank

5 pipe

6 haul-off with a saw

8 ultrasound measuring device

9a, 9b, 9i sensors of the ultrasound measuring device

9x passive sensor

10 controller device

12 pipe wall

14 emitted ultrasound waves

14-1 ultrasound waves reflected from the pipe wall 12

14-2 ultrasound waves reflected back from the sensor

14-3 return signals

14-4 reflection of the return signals 14-3

14-5 second return signals

16 reflection limiting means, in particular, sound attenuating means or reflectors

A axis

alpha angle of offset of the sensors 9i in relation to one another

d longitudinal spacing of the sensors 9i in relation to one another

Pi measuring peaks

S measuring signal

ti points in time

1. An ultrasound measuring device for measuring extruded products in an extrusion line, the ultrasound measuring device comprising
multiple sensors, each emitting ultrasound waves and detecting reflected ultrasound waves, the sensors being distributed around an axis and aligned towards the axis,
a controller device for activating the sensors and receiving measuring signals from the sensors,
wherein the multiple sensors are arranged, in relation to one another,
helical or spiral around the axis, and/or
sequentially offset in relation to one another both in the circumferential direction around the axis and in the direction of the axis,
the controller device activating the sensors in such a way that always one sensor transmits and detects and the other sensors detect passively.

2. The ultrasound measuring device of claim 1, wherein the controller device activates the sensors in such a way that successively always another one of the sensors actively transmits and detects and the other sensors detect passively.

3. The ultrasound measuring device of claim 1, wherein the sensors form a symmetric helix, with an even offset angle in the circumferential direction and an even longitudinal spacing in the direction of the axis.

4. The ultrasound measuring device of claim 1, wherein the controller device activates the helical arrangement of the multiple sensors sequentially in series in such a way that always one of the sensors is active and transmits and receives, and the other sensors are passive and detect, in particular, in a cyclic active activation of all sensors but at least one further, in particular, last sensor, the at least one further sensor detecting only passively, so as generate equal or corresponding measuring signals of the multiple measurements.

5. The ultrasound measuring device of claim 1, wherein the controller device is configured to activate the helical arrangement of sensors in series in a sequence deviating from the geometric sequence in the helix.

6. The ultrasound measuring device of claim 1, wherein the controller device is configured to activate at least two sensors spaced apart in the geometric sequence in a manner temporally overlapping and/or simultaneously as active sensors, in particular, when reflections are not overlapping, where the passive sensors pick up only signals from one of the transmitting sensors.

7. The ultrasound measuring device of claim 1, wherein multiple helical arrangements of sensors are interlaced with one another in such a way that the spirals or helixes are offset against one another in the axial direction, in particular, such that no sensors of the multiple helical arrangements lie opposite one another, in particular, with separate activation of the individual helixes.

8. The ultrasound measuring device of claim 1, wherein at least two helical arrangements of sensors are interlaced with one another in such a way that at least some of the sensors of the at least two helixes lie opposite one another, where the controller device carries out a determination of an interior diameter and/or exterior diameter of the extruded product from a measurement in which an active sensor of one of the helixes transmits and the sensor of the other helix lying opposite receives.

9. The ultrasound measuring device of claim 1, wherein opposite at least some sensors lies a sound affecting means, e.g., a reflector or an attenuating means, so as to prevent or reduce reflections.

10. The ultrasound measuring device of claim 1, wherein the controller device is configured to determine one or more of the following properties from the measuring signals, in particular, from time-of-flight differences and/or the allocation of the passive to the active sensor:
one or more layer thickness(es),
an exterior diameter and/or interior diameter,
faults, e.g., shrinkage cavities and/or inclusions and/or irregularities of the surfaces, e.g., sagging,
material properties of the extruded product, in particular, a speed of sound in the material and/or an acoustic impedance.

11. A method for measuring an extruded product, where the extruded product is transported during the extrusion process along an axis and continuously measured by at least one ultrasound measuring device including multiple sensors, the multiple sensors being
arranged successively in both the circumferential direction around the axis and offset in relation to one another in the direction of the axis, and/or
arranged helically or spirally around the axis,
wherein an active-passive measurement always one of the sensors transmits and receives and the other sensors detect passively.

12. The method of claim 11, wherein one of the multiple sensors are each activated successively as the active sensor, and the measurement is carried out repeatedly in a cycle, in particular, each of the sensors or all sensors but at least one last sensor.

13. The method of claim 12, wherein at least one last sensor of the multiple sensors in the sequential arrangement merely measures passively so as to generate equal measuring signals.

14. The method of claim 11, wherein the extruded product is measured continuously in its full circumference.

15. The method of claim 11, wherein an extruded product is measured from the group consisting of: pipes, hoses, profiles, sheets, cables, wires, in particular, made of plastics or rubber e.g., made of continuous or foamed material.

16. The method of claim 11, wherein one or more of the following properties are determined from the measuring signals:
one or more layer thickness(es),
an exterior diameter and/or interior diameter,
faults, e.g., shrinkage cavities and/or inclusions and/or irregularities of the surfaces, e.g., sagging,
material properties of the extruded product, in particular, a speed of sound in the material and/or an acoustic impedance.
